(19) United States
(12) Patent Application Publication
(10) Pub. No.: US 2005/0112028 A1
(43) Pub. Date: May 26, 2005

(54) Surface plasmon resonance sensor and sensor unit

(75) Inventors: Hisashi Ohtsuka, Kanagawa-ken (JP); Toshihito Kimura, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/947,285

(22) Filed: Sep. 23, 2004

(30) Foreign Application Priority Data
Sep. 24, 2003 (JP) 331549/2003

(51) Int. Cl. G01N 21/00

(52) U.S. Cl. 422/82.11; 422/82.05

(57) ABSTRACT

A surface plasmon resonance sensor includes a light source emitting a light beam, a metal film provided on one surface of the dielectric block of a sensor unit, a light beam projecting system which causes the light beam to enter the dielectric block to impinge upon the interface between said one surface of the dielectric block and the metal film so that total internal reflection conditions are satisfied at the interface, and a photodetector which detects the intensity of the light beam reflected in total internal reflection at the interface and detects a state of attenuation in total internal reflection. The relation −2×10⁻⁵≦(n3·Δn1−n1·Δn3)≦2×10⁻⁵ is satisfied wherein n1 and n3 represent refractive indexes of the solvent of the sample liquid and the dielectric block, and Δn1 and Δn3 represent the rates of temperature-change of the refractive indexes of the solvent of the sample liquid and the dielectric block.

### BACKGROUND OF THE INVENTION

1. Field of the Invention

This invention relates to a surface plasmon resonance sensor for quantitatively analyzing a material in a sample on the basis of generation of surface plasmon and a sensor unit for use in the surface plasmon resonance sensor.

2. Description of the Related Art

In metal, free electrons vibrate in a group to generate compression waves called plasma waves. The compression waves generated in a metal surface are quantized into surface plasmon.

There have been proposed various surface plasmon resonance sensors for quantitatively analyzing a material in a sample utilizing a phenomenon that such surface plasmon is excited by light waves. Among those, one employing a system called “Kretschmann configuration” is best known. See, for instance, Japanese Unexamined Patent Publication No. 6(1994)-167443.

The surface plasmon resonance sensor using the Kretschmann configuration basically comprises a dielectric block shaped, for instance, like a prism, a metal film which is formed on one face of the dielectric block and is brought into contact with a sample, a light source emitting a light beam, an optical system which causes the light beam to enter the dielectric block at various angles of incidence so that total internal reflection conditions are satisfied at the interface of the dielectric block and the metal film and various angles of incidence of the light beam to the interface of the dielectric block and the metal film including an angle of incidence at which attenuation in total internal reflection is generated due to surface plasmon resonance can be obtained, and a photodetector means which detects the intensity of the light beam reflected in total internal reflection at the interface and detects a state of attenuation in total internal reflection.

In order to obtain various angles of incidence of the light beam to the interface, a relatively thin incident light beam may be caused to impinge upon the interface changing the angle of incidence or a relatively thick incident light beam may be caused to impinge upon the interface in the form of convergent light or divergent light so that the incident light beam includes components impinging upon the interface at various angles. In the former case, the light beam which is reflected from the interface at an angle which varies as the angle of incidence changes may be detected by a photodetector which is moved in synchronization with the change of the angle of incidence or by an area sensor extending in the direction in which reflected light beam is moved as the angle of incidence changes. In the latter case, an area sensor which extends in directions so that all the components of light reflected from the interface at various angles can be detected by the area sensor may be used.

In such a surface plasmon resonance sensor, when a light beam impinges upon the metal film at a particular angle of incidence Osp not smaller than the angle of total internal reflection, evanescent waves having an electric field distribution in the sample in contact with the metal film are generated and surface plasmon is excited in the interface between the metal film and the sample. When the wave number vector of the evanescent light is equal to the wave number of the surface plasmon and wave number matching is established, the evanescent waves and the surface plasmon resonate and light energy is transferred to the surface plasmon, whereby the intensity of light reflected in total internal reflection at the interface of the dielectric block and the metal film sharply drops. The sharp intensity drop is generally detected as a dark line by the photodetector.

The aforesaid resonance occurs only when the incident light beam is p-polarized. Accordingly, it is necessary to set the surface plasmon sensor so that the light beam impinges upon the interface in the form of p-polarized light or p-polarized components are only detected.

When the wave number of the surface plasmon can be known from the angle of incidence θsp at which the phenomenon of attenuation in total internal reflection (ATR) takes place, the dielectric constant of the sample can be obtained. That is,

$${K}_{sp} ( ω ) = \frac{ω}{c} \sqrt{\frac{{ɛ}_{2} ( ω ) {ɛ}_{1}}{{ɛ}_{2} ( ω ) + {ɛ}_{1}}}$$

wherein Kₛₚ represents the wave number of the surface plasmon, ω represents the angular frequency of the surface plasmon, c represents the speed of light in a vacuum, and εm and εs respectively represent the dielectric constants of the metal and the sample.

When the dielectric constant ε₁ of the sample is known, the concentration of a specific material in the sample can be determined on the basis of a predetermined calibration curve or the like. Accordingly, the specific material can be quantitatively detected by detecting the angle of incidence θsp at which the intensity of light reflected in total internal reflection from the interface of the prism and the metal film sharply drops (this angel θsp will be referred to as “the attenuation angle θsp”, hereinbelow).

Such a measuring apparatus is employed, as a biosensor, to analyze a sample, that is, a sensing medium (e.g. antibody), which combines with a particular material (e.g., antigen), is disposed on the metal film and whether the sample includes a material combined with the sensing medium or the state of combination of the sample with the sensing medium is detected. As a method of analyzing a sample in this way, there has been proposed a method in which, in order to eliminate the influence of the solvent (e.g., physiological saline) in the sample liquid on the refractive index of the sample liquid, refractive index information on buffer (the same as the solvent) free from the analyte (material to be analyzed) is first obtained and then the sample liquid is dispensed to the buffer to measure the refractive index information of the mixture after the reaction, whereby only the reaction of the analyte is precisely extracted.

However, there has been a problem that the measured value of the refractive index n of the sample liquid is affected by the change of the temperature. See, for instance, “Analytical Chemistry”, 1999, vol. 71, pp 4392 to 4396. For example, the measured value of the refractive index n of the sample liquid fluctuates by dn/dt≈1×10⁻⁴. Since, a change of the measured value of the refractive index n by 1×10⁻⁶ appears fluctuation in the signal by 1RU(=0.0001°) (“Journal of Colloid and Interface Science, 1991, vol. 143, No. 2, pp 513 to 526), the fluctuation of the measured value of the refractive index n of the sample liquid fluctuates by 1×10⁻⁴ corresponds to fluctuation of the signal by about 100(RU/° C.).

In order to increase the reproducibility to about 10% of a CV value when detection is made at a high sensitivity of about 1RU, it is necessary to suppress the fluctuation of the signal to be 0.1RU at most. Temperature control of 0.001° C. is necessary to suppress the fluctuation of the signal to be 0.1RU at most. Though it is possible temperature control of 0.01° C., temperature control of 0.001° C. is practically impossible. Accordingly, at present, fluctuation of the signal of 1RU must be accepted.

### SUMMARY OF THE INVENTION

In view of the foregoing observations and description, the primary object of the present invention is to provide a surface plasmon resonance sensor which can conduct reliable high-sensitivity measurement up to 1RU.

A formula representing the angle θ of the dark line based on the surface plasmon resonance (a formula of the SPR signal) is expressed as a function including therein refractive indexes (the real parts) n1, n2 and n3 of the solvent, the metal film and the dielectric block. Though the influence of the temperature fluctuation t is contained in those indexes n, it is neglected in general. These inventors have succeeded to analytically derive the relation between the temperature-dependency (dθ/dt) of the angle of the dark line and the physical property (dn/dt) of the sample liquid and the cup by representing the formula of the SPR signal as a term of the temperature fluctuation. The relation derived by these inventors is as follows, wherein ε1 represents the dielectric constant of the solvent of the sample liquid, ε2 represents the dielectric constant of the metal film and ε3 represents the dielectric constant of the dielectric block. The angle θ (rad) of the dark line which is an angle of the surface plasmon signal can be approximated as follows as a function taking a real part.

$$θ = Re ( {sin}^{- 1} \{ \frac{1}{\sqrt{ɛ3}} {( \frac{ɛ2 \times ɛ1}{ɛ2 + ɛ1} )}^{0.5} \} ) = Re ( {sin}^{- 1} \{ \frac{\sqrt{ɛ1}}{\sqrt{ɛ3}} {( \frac{ɛ2}{ɛ2 + ɛ1} )}^{0.5} \} ) \\ = Re ( {sin}^{- 1} \{ \frac{\sqrt{ɛ1}}{\sqrt{ɛ3}} \times \frac{1}{\sqrt{1 + \frac{ɛ1}{ɛ2}}} \} ) \qquad ( 2 )$$

When the metal is gold or silver, |ε1|<<|ε2|,
Accordingly,

$$K ≡ \frac{1}{\sqrt{1 + \frac{ɛ1}{ɛ2}}}$$

can be considered to be a constant, and
the formula (2) can be expressed as

$$θ = Re ( {sin}^{- 1} \{ K \times \frac{\sqrt{ɛ1}}{\sqrt{ɛ3}} \} ) \qquad ( 3 )$$

Since ε1 and ε3 contain no imaginary part, the formula (3) can be represented by only the real numbers as the following formula (4).
θ=sin⁻¹K×n1/n3) (4)

The refractive index n is not constant independently of the temperature and fluctuates as represented by (n+Δn×t) with the temperature fluctuation t during measurement. The formula (4) can be rewritten as follows taking into account this as a function including the temperature fluctuation t.

$$θ ( t ) = {sin}^{- 1} ( K \times \frac{n1 + Δ n1 \times t}{n3 + Δ n3 \times t} )$$

wherein n1=dn1/dt and Δn3=dn3/dt.

Though K fluctuates with t strictly, it is possible to consider K as a constant for the reason above.

When t is sufficiently small, the change of θ(t) with a fine temperature fluctuation t can be displaced with a differentiation and can be expressed by the following formula (5).

$$ⅆ θ / ⅆ t = {( 1 - {K}^{2} \times {\{ \frac{n1 + Δ n1 \times t}{n3 + Δ n3 \times t} \}}^{2} )}^{0.5} \times K \times \frac{n3 \times Δ n1 - n1 \times Δ n3}{{( n3 \times Δ n3 \times t )}^{2}} \\ = {K}^{′} ( t ) \times ( n3 \times Δ n1 - n1 \times Δ n3 ) \qquad ( 5 )$$

wherein

$${k}^{′} ( t ) = {( 1 - {K}^{2} \times {\{ \frac{n1 + Δ n1 \times t}{n3 + Δ n3 \times t} \}}^{2} )}^{- 0.5} \times K \times \frac{1}{{( n3 + Δ n3 \times t )}^{2}}$$

The above replacement is reasonable since the measuring device is somewhat temperature-controlled (temperature fluctuation |t|≦1° C.) in order to effect highly accurate measurement of not larger than 100RU.

In the range of the temperature fluctuation, the change of K′(t) is less sensitive to change of t, and accordingly, K′(t) may be considered to be a constant. When aqueous solution (e.g., pure water, physiological saline or the like) is used as the solvent, the value of K′(t) may be considered to be 0.95.

At this time, the above formula (5) representing the surface plasmon resonance signal versus the temperature can be rewritten as follows.

$$ⅆ θ / ⅆ t \approx 0.95 \times ( n3•Δ n1 - n1•Δ n3 ) ( rad \text{/} °C . ) \\ = 57 \times 0.95 \times ( n3•Δ n1 - n1•Δ n3 ) ( deg . \text{/} ° C . )$$

Since, 1 deg.=10⁴RU
dθ/dt≈5.42×10⁵×(n3·Δn1−Δn1·Δn3)(RU/° C.)

Accordingly, when n3·Δn1−n1·Δn3=0, dθ/dt=0, which means that the temperature dependency is nullified, which is optimal. However, the desired accuracy can be satisfied, when −10RU≦dθ/dt≦10RU.

This invention has been made on the basis of this recognition.

In accordance with one aspect of the present invention, there is provided a surface plasmon resonance sensor comprising
a light source emitting a light beam,
a sensor unit formed by a dielectric block transparent to the light beam, a metal film provided on one surface of the dielectric block, and a sample holding portion which holds a sample on the metal film,
a light beam projecting means which causes the light beam to enter the dielectric block to impinge upon the interface between said one surface of the dielectric block and the metal film so that total internal reflection conditions are satisfied at the interface, and
a photodetector means which detects the intensity of the light beam reflected in total internal reflection at the interface and detects a state of attenuation in total internal reflection, wherein the improvement comprises that
the relation −2×10⁻⁵≦(n3·Δn1−n1·Δ3)≦2×10⁻⁵ is satisfied wherein n1 and n3 represent refractive indexes of the solvent of the sample liquid and the dielectric block, and Δn1 and Δn3 represent the rates of temperature-change dn1/dt and dn3/dt of the refractive indexes of the solvent of the sample liquid and the dielectric block.

In accordance with another aspect of the present invention, there is provided a sensor unit comprising
a dielectric block transparent to the light beam, a metal film provided on one surface of the dielectric block, and
a sample holding portion which holds a sample on the metal film, wherein the improvement comprises that
the relation −2×10⁻⁵≦(n3·Δn1−n1·Δn3)≦2×10⁻⁵ is satisfied wherein n1 and n3 represent refractive indexes of the solvent of the sample liquid and the dielectric block, and Δn1 and Δn3 represent the rates of temperature-change dn1/dt and dn3/dt of the refractive indexes of the solvent of the sample liquid and the dielectric block.

Specifically, when pure water or physiological saline is used as the solvent, the dielectric block of the sensor unit may comprise Zeonex E48R (ZEON CORPORATION).

The following table 1 shows rates of temperature-change dθ/dt of the measured value when pure water (n1=1.33, Δn1=−8×10⁻⁵) or physiological saline (n1=1.36, Δn1=−8×10⁻⁵) is used as the solvent and dielectric blocks which are about the same in the refractive index n3 and different in Δn3 are employed.

TABLE 1

| Δn3 | pure water | physiological saline |
|---|---|---|
| [×10⁻⁵] | dθ/dt [RU/° C.] | dθ/dt [RU/° C.] |
| 0 | −65.04 | −65.04 |
| −1 | −57.83 | −57.67 |
| −7 | −14.58 | −13.44 |
| −8 | −7.37 | −6.07 |
| −9 | −0.16 | 1.30 |
| −10 | 7.05 | 8.67 |
| −11 | 14.25 | 16.04 |

As can be understood from table 1, dθ/dt can be suppressed within about 10RU/° C., when the rates of temperature-change Δn3 of the dielectric block is in the range of −7×10⁵<Δn3<−11×10⁻⁵ in the case where pure water or physiological saline is used as the solvent.

In accordance with the present invention, −2×10⁻⁵≦(n3·Δn1−n1·Δn3)≦2×10⁻⁵ is satisfied. This is substantially equivalent to −10RU≦dθ/dt≦10RU. That is, the attenuation angle signal fluctuates within 10RU by temperature-fluctuation of 1° C. However, when a temperature control of 0.01° C. is conducted, fluctuation in the attenuation angle signal can be suppressed to within 0.1RU, whereby a high accuracy measurement which is required a reliability up to 1RU can be effected. When a combination of the solvent and the dielectric block having indexes and the rates of temperature-range which satisfy dθ/dt=0 is selected, it is possible to nullify the change of the signal with temperature.

### BRIEF DESCRIPTION OF THE DRAWINGS

FIG. 1 is a side view of a surface plasmon resonance sensor in accordance with a first embodiment of the present invention, and

FIG. 2 is a view showing the relation between the angle of incidence of the light beam to the interface and the intensity of the detected light beam.

### DESCRIPTION OF THE PREFERRED EMBODIMENTS

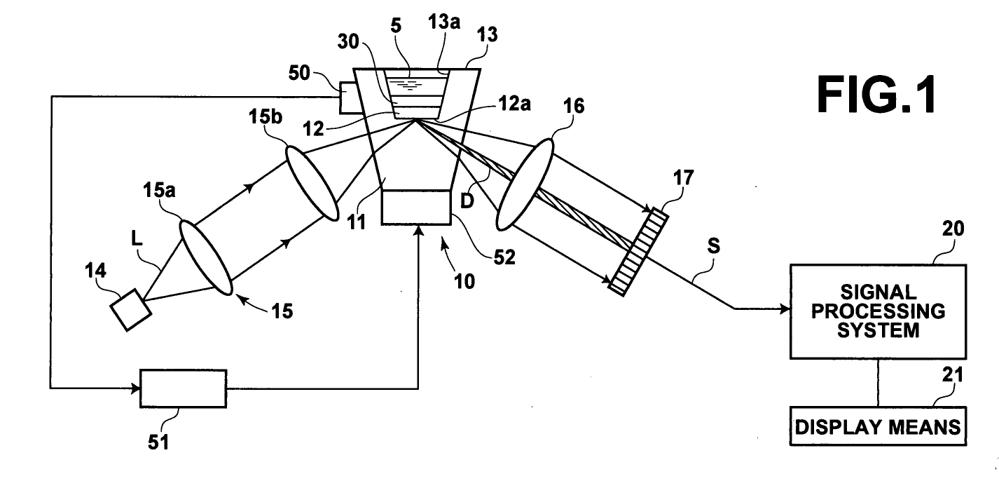

In FIG. 1, a surface plasmon resonance sensor of this embodiment comprises a measuring chip 10 (a type of the sensor unit), a laser 14 which may comprise, for instance, a semiconductor laser which emits a light beam L for measurement (a laser beam), a light beam projecting optical system 15 which causes the light beam L to impinge upon the measuring chip 10, a collimator lens 16, a photodetector 17, a signal processing system 20 which controls drive of the laser 14 and effects the process to be described later upon receipt of the output signal S of the photodetector 17, a display means 21 connected to the signal processing system 20.

The measuring chip 10 comprises a dielectric block 11 substantially of a rectangular pyramid, a metal film 12 (e.g., gold or silver) which is formed on one surface of the dielectric block 11, a sample holding frame 13 of a tubular member which defines a laterally closed space above the metal film 12. The sample holding frame 13 is circular in cross-section and the inner surface thereof flares upward. The flared space in the sample holding frame 13 functions as a well 13a in which sample liquid 5 is stored. The dielectric block 11 and the sample holding frame 13 are integrally molded by transparent resin having a refractive index to be described later. A sensing medium 14, which is combined with a particular material, is fixed on the metal film 12.

The transparent resin forming the dielectric block 11 has a refractive index which satisfies the relation −2×10⁻⁵≦(n3·Δn1−n1·Δn3)≦2×10⁻⁵ wherein n1 and n3 represent refractive indexes of the solvent of the sample liquid 5 and the dielectric block 11, and Δn1 and Δn3 represent the rates of temperature-change dn1/dt and dn3/dt of the refractive indexes of the solvent of the sample liquid 5 and the dielectric block 11.

The light beam projecting optical system 15 collects the light beam L and causes the light beam L to enter the dielectric block 11 in a collected state to impinge upon the interface 12a between the dielectric block 11 and the metal film 12 at various angles of incidence. The light beam projecting optical system 15 comprises a collimator lens 15a which converts the light beam L emitted from the laser 14 as a divergent light beam, into a parallel light, and a condenser lens 15b which condenses the collimated light beam L on the interface 12a. The angle of incidence of the light beam L to the interface 12a is in such a range that total internal reflection conditions are satisfied and surface plasmon resonance occurs at the interface 12a.

The light beam L is caused to impinge upon the interface 12a in a p-polarized state. This can be realized by positioning the laser 14 so that its direction of polarization is directed in a predetermined direction. Otherwise, the direction of polarization of the light beam L may be controlled by a wavelength plate or a polarizing plate.

The photodetector 17 comprises a line sensor formed of a plurality of photosensor elements which are arranged in a row extending in a direction of arrow X in FIG. 1. The light beam L is converted into a parallel light beam by a collimator lens 16 after reflected in total internal reflection at the interface 12a, and then detected by the photodetector 17.

In this particular embodiment, the surface plasmon resonance sensor has a temperature-control means comprising a thermistor 50 which measures the temperature of the dielectric block 11, a Peltier element 52 which controls a temperature and a driver 51 which drives the Peltier element 52. The temperature-control may be effected in other various ways. For example, though the thermistor 50 is in contact with a side surface of the dielectric block 1 in this embodiment, the thermistor 50 may be located in any position so long as it can measure the temperature of the dielectric block 11 if a thermal equilibrium is established between the dielectric block 11 and the environment. Though the Peltier element 52 is located on the bottom of the bottom of the dielectric block 11, it need not be disposed there.

The temperature-control means controls the temperature during measurement within about 0.01° C.

Sample analysis by the surface plasmon resonance sensor of this embodiment will described, hereinbelow. The measuring chip 10 is supplied with the sample liquid 5.

The laser 14 is driven under instruction of the signal processing system 20 and a light beam L is emitted from the laser 14 impinges upon the interface 12a between the dielectric block 11 and the metal film 12. The light beam L impinging upon the interface 12a is reflected in total internal reflection at the interface 12a and the reflected light beam L is detected by the photodetector 17.

As shown in FIG. 1, the light beam L emitted from the laser 14 as a divergent light beam is focused on the interface 12a. Accordingly, the light beam L includes components impinging upon the interface at various angles of incidence of the light beam L to the interface 12a and the reflected light beam L includes components reflected at the interface 12a at various angles of reflection.

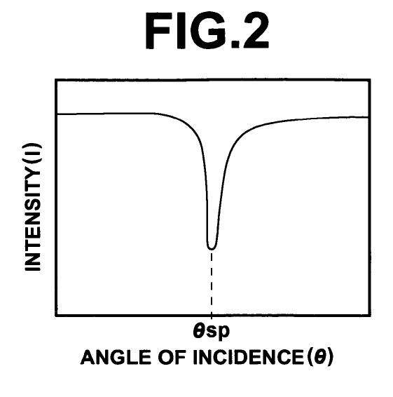

The component of the light beam L impinging upon the interface 12a at a particular angle of incidence θsp excites surface plasmon in the interface 12a between the metal film 12 and material in contact with the metal film 12 and the intensity of the component reflected in total internal reflection sharply drops. That is, the particular angle of incidence θsp is the attenuation angle or the angle at which the total internal reflection is cancelled and the intensity of the reflected light beam exhibits a minimum value at the angle of incidence θsp. The region where the intensity I of the reflected light beam sharply drops is generally observed as a dark line D in the reflected light beam L. FIG. 2 is a view showing the relation between the angle of incidence θ of the light beam L to the interface and the intensity I of the light beam received by the photodetector 17.

The signal processing system 20 detects the amounts of light detected by the photosensor elements on the basis of the signal S output from the photodetector 17 and determines the attenuation angle θsp on the basis of the position of the photosensor element detecting the dark line.

The light beam projecting optical system 15 may be arranged to cause the light beam L to impinge upon the interface 12a in a defocused state. In this way, errors in measurement of the state of surface plasmon resonance (e.g., measurement of the position of the dark line) are averaged and the measuring accuracy can be improved.

Since the sensing medium 14 is fixed to the surface of the metal film 12 in this embodiment, the refractive index of the sensing medium 14 on the metal film 12 changes with change of the state of combination of the particular material with the sensing medium 14. By continuing to measure change of the attenuation angle θsp, change in the state of combination of the particular material with the sensing medium 14 can be investigated.

That is, when the attenuation angle θsp changes with time, it may be determined that the particular material contained in the sample liquid 5 combines with the sensing medium 14. Whereas, when the attenuation angle θsp does not change with time, it may be determined that there is no particular material contained in the sample liquid 5. On the basis of the principle described above, the signal processing system 20 detects whether the particular material is in the sample liquid 5, and causes the display means 21 to display the result of detection.

In this particular embodiment, the temperature during measurement is controlled within about 0.01° C. by the temperature-control means. As described above, in the past, it has been impossible to obtain a reliability of 1RU in the measured value in measuring devices which accept a temperature fluctuation up to 0.01° C.

However, in this embodiment, fluctuation in the refractive index per 1° C. can be suppressed to about 10RU, and accordingly, when temperature-control is conducted at an accuracy of 0.01° C., the fluctuation in the refractive index can be suppressed to about 1RU, and reliable high-sensitivity measurement up to 1RU can be realized.

A combination of pure water or physiological saline (as the solvent) and Zeonex E48R (ZEON CORPORATION) (as the material of the dielectric block) can be, for instance, used.

The values of dθ/dt when Zeonex E48R is employed as the material of the dielectric block 11 and pure water and physiological saline are employed as the solvent are listed in the following table 2.

TABLE 2

| | | Δn1 | Zeonex E48R | | dθ/dt |
|---|---|---|---|---|---|
| | n1 | (×10⁻⁵) | n³ | Δn3 (×10⁻⁵) | (RU/° C.) |
| pure water | 1.328 | −8 | 1.50 | −8.87 | −1.2 |
| physiological | 1.36 | −8 | | | +0.3 |
| saline | | | | | |

As can be seen from the above table 2, in the case of pure water and physiological saline, the values of dθ/dt are both very small, and accordingly, when temperature-control is conducted at an accuracy of 0.01° C., reliable high-sensitivity measurement up to 1RU can be realized. Especially, in the case of physiological saline, the measured value can be obtained at a very high accuracy and reliable high-sensitivity measurement up to 1RU can be realized even when accuracy of temperature-control is only 0.3° C.

The values of dθ/dt when different materials are employed as the material of the dielectric block 11 with physiological saline employed as the solvent are listed in the following table 3.

TABLE 3

| | n3 | Δn3(×10⁻⁵) | dθ/dt(Ru/° C.) |
|---|---|---|---|
| Zeonex E48R | 1.50 | −8.87 | 0.3 |
| Zeonex 330R | 1.50 | −11 | 16.0 |
| Polymethyl | 1.49 | −10.3 | 10.9 |
| metacrylate | | | |
| Polycarbonate | 1.59 | −11.6 | 16.1 |
| BK7 | 1.517 | 0.24 | −67.5 |
| FK52 | 1.486 | −0.68 | −59.4 |

As can be understood from table 3, the absolute value of dθ/dt constantly exceeds 10 when the dielectric block 11 is formed by a material other than Zeonex E48R, and accordingly, it is impossible to realize reliable high-sensitivity measurement up to 1RU even when temperature-control is conducted at an accuracy of 0.01° C. The values of the refractive index and the rates of temperature-change are given by data in catalogue from SCHOTT.

1. A surface plasmon resonance sensor comprising
a light source emitting a light beam,
a sensor unit formed by a dielectric block transparent to the light beam, a metal film provided on one surface of the dielectric block, and a sample holding portion which holds a sample on the metal film,
a light beam projecting means which causes the light beam to enter the dielectric block to impinge upon the interface between said one surface of the dielectric block and the metal film so that total internal reflection conditions are satisfied at the interface, and
a photodetector means which detects the intensity of the light beam reflected in total internal reflection at the interface and detects a state of attenuation in total internal reflection, wherein the improvement comprises that
the relation −2×10⁻⁵≦(n3·Δn1−n1·Δn3)≦2×10⁻⁵ is satisfied wherein n1 and n3 represent refractive indexes of the solvent of the sample liquid and the dielectric block, and Δn1 and Δn3 represent the rates of temperature-change dn1/dt and dn3/dt of the refractive indexes of the solvent of the sample liquid and the dielectric block.

2. A sensor unit comprising
a dielectric block transparent to the light beam, a metal film provided on one surface of the dielectric block, and
a sample holding portion which holds a sample on the metal film, wherein the improvement comprises that
the relation −2×10⁻⁵≦(n3·Δn1−n1·Δn3)≦2×10⁻⁵ is satisfied wherein n1 and n3 represent refractive indexes of the solvent of the sample liquid and the dielectric block, and Δn1 and Δn3 represent the rates of temperature-change dn1/dt and dn3/dt of the refractive indexes of the solvent of the sample liquid and the dielectric block.
